(19) United States
(12) Patent Application Publication
(10) Pub. No.: US 2026/0064404 A1
(43) Pub. Date: Mar. 5, 2026

(54) METHOD, APPARATUS, DEVICE AND MEDIUM FOR SWITCHING CODE DATA

(71) Applicants: Lemon Inc., Grand Cayman (KY); Beijing Zitiao Network Technology Co., Ltd., Haidian District, Beijing (CN)

(72) Inventors: Pengwen Jiao, Culver City, CA (US); Yilei Wang, Beijing (CN)

(21) Appl. No.: 18/932,917

(22) Filed: Oct. 31, 2024

Related U.S. Application Data
(63) Continuation of application No. PCT/CN2024/115637, filed on Aug. 29, 2024.

(51) Int. Cl. G06F 8/70; G06F 8/10; G06F 8/53

(52) U.S. Cl. CPC G06F 8/70; G06F 8/10; G06F 8/53

(57) ABSTRACT

A method, an apparatus, a device, and a medium for switching code data are provided. Description data of a project is obtained, the description data describing an association relationship between code data of a plurality of modules in the project and the project, and a reference mode of code data of a module in the plurality of modules comprising at least any of: a binary mode and a source code mode. In response to determining that the reference mode of first code data of a first module in the plurality of modules is switched from the binary mode to the source code mode, second configuration data of the first module is generated based on first configuration data of the first module. The description data of the project is updated with the second configuration data. Development efficiency is improved without the need to synchronize code data of the entire project.

### CROSS-REFERENCE

This application claims priority to Patent Application No. PCT/CN2024/115637, filed with the China National Intellectual Property Administration on Aug. 29, 2024, and entitled “METHOD, APPARATUS, DEVICE AND MEDIUM FOR SWITCHING CODE DATA”, the disclosures of which are incorporated herein by reference in their entirety.

### FIELD

Example implementations of the present disclosure relate generally to the development of applications, and in particular to a method, an apparatus, a device, and a computer-readable storage medium for switching code data in a software development process.

### BACKGROUND

As the scale of applications continues to expand, the number of modules included in an application is increasing, thereby resulting in a corresponding increase in the amount of code data in a project created for developing applications. There may be two modes for code data: a binary mode and a source code mode, and switching may need to be performed between a binary mode and a source code mode during development. The switching process will trigger re-synchronization of the code data, and synchronization may result in a longer time delay. At this time, it is desirable to switch the code data in a more rapid and efficient manner, thereby improving the overall development efficiency of the application.

### SUMMARY

In a first aspect of the present disclosure, a method for switching code data is provided. In the method, description data of a project is obtained, the description data describing an association relationship between code data of a plurality of modules in the project and the project, and a reference mode of code data of a module in the plurality of modules comprising at least any of: a binary mode and a source code mode. In response to determining that the reference mode of first code data of a first module in the plurality of modules is switched from the binary mode to the source code mode, second configuration data of the first module is generated based on first configuration data of the first module. The description data of the project is updated with the second configuration data.

In a second aspect of the present disclosure, an apparatus for switching code data is provided. The apparatus comprises an obtaining module configured to obtain description data of a project, the description data describing an association relationship between code data of a plurality of modules in the project and the project, and a reference mode of code data of a module in the plurality of modules comprising at least any of: a binary mode and a source code mode; a generating module configured to generate, in response to determining that the reference mode of first code data of a first module in the plurality of modules is switched from the binary mode to the source code mode, second configuration data of the first module based on first configuration data of the first module; and an updating module configured to update the description data of the project with the second configuration data.

In a third aspect of the present disclosure, an electronic device is provided. The electronic device comprises: at least one processing unit; and at least one memory coupled to the at least one processing unit and storing instructions for execution by the at least one processing unit that, when executed by the at least one processing unit, cause the electronic device to perform a method according to the first aspect of the present disclosure.

In a fourth aspect of the present disclosure, there is provided a computer readable storage medium having stored thereon a computer program which, when executed by a processor, causes the processor to implement the method according to the first aspect of the present disclosure.

In a fifth aspect of the present disclosure, there is provided a computer program product, comprising a computer program, where the computer program, when executed by a processor, implements the method according to the first aspect of the present disclosure.

It should be appreciated that what is described in this Summary is not intended to limit the key features or essential features of the implementations of the present disclosure, nor is it intended to limit the scope of the present disclosure. Other features of the present disclosure will become readily appreciated from the following description.

### BRIEF DESCRIPTION OF DRAWINGS

Hereinafter, the above and other features, advantages, and aspects of various implementations of the present disclosure will become more apparent with reference to the following detailed description taken in conjunction with the accompanying drawings. In the drawings, identical or similar reference numbers denote identical or similar elements, where:

FIG. 1 illustrates a block diagram of a development environment for an application according to an exemplary implementation of the present disclosure;

FIG. 2 illustrates a block diagram for switching code data according to some implementations of the present disclosure;

FIG. 3 illustrates a block diagram of a directory structure involved in a project according to some implementations of the present disclosure;

FIG. 4 illustrates a block diagram of a structure for description data according to some implementations of the present disclosure;

FIG. 5 illustrates a block diagram of a structure of configuration data according to some implementations of the present disclosure;

FIG. 6 illustrates a flowchart of a method for switching code data according to some implementations of the present disclosure;

FIG. 7 illustrates a block diagram of an apparatus for switching code data according to some implementations of the present disclosure; and

FIG. 8 illustrates a block diagram of a device capable of implementing various implementations of the present disclosure.

### DETAILED DESCRIPTION

Implementations of the present disclosure will be described in more detail below with reference to the accompanying drawings. While certain implementations of the present disclosure are shown in the drawings, it should be understood that the present disclosure may be implemented in various forms and should not be construed as limited to the implementations set forth herein; rather, these implementations are provided for a thorough and complete understanding of the present disclosure. It should be understood that the drawings and implementations of the present disclosure are only for exemplary purposes and are not intended to limit the scope of protection of the present disclosure.

In the description of implementations of the present disclosure, the term “comprising” and its similar words should be understood as open-ended including, that is, “comprising but not limited to”. The term “based on” should be read as “based at least in part on”. The term “one implementation” or “the implementation” should be read as “at least one implementation”. The term “some implementations” should be understood as “at least some implementations”. Other explicit and implicit definitions may also be included below. As used herein, the term “model” may denote an association relationship between respective data. The association relationship may be obtained, for example, based on a variety of technical solutions that are currently known and/or will be developed in the future.

It is to be understood that the data involved in the technical solution (including but not limited to the data itself, the acquisition or use of the data) should comply with the requirements of the corresponding legal regulations and related provisions.

It should be understood that, before the technical solutions disclosed in the embodiments of the present disclosure are used, the user should be informed of the type of the personal information, the usage range, the usage scenario, and the like related to the present disclosure and the authorization of the user should be obtained in an appropriate manner according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, a manner of sending prompt information to a user in response to receiving an active request from the user may be, for example, a manner of popping up a window, and the prompt information may be presented in a text manner in the pop-up window. In addition, the pop-up window may also carry a selection control for the user to select “agree” or “do not agree” to provide personal information to the electronic device.

It can be understood that, the above processes of notifying and obtaining the user authorization are only illustrative, and do not limit the implementation of the present disclosure, and other methods meeting relevant legal regulations may also be applied to the implementation of the present disclosure.

As used herein, the term “in response to” refers to a state in which a corresponding event occurs or a condition is satisfied. It will be appreciated that the execution timing for a subsequent action that is executed in response to the event or condition is not necessarily strongly correlated with the time when the event or condition occurs or is satisfied. For example, in some cases, subsequent actions may be performed immediately upon occurrence of an event or upon satisfaction of a condition; in some other cases, subsequent actions may be performed only after a period of time has elapsed since an event occurs or a condition is satisfied.

### Example Environment

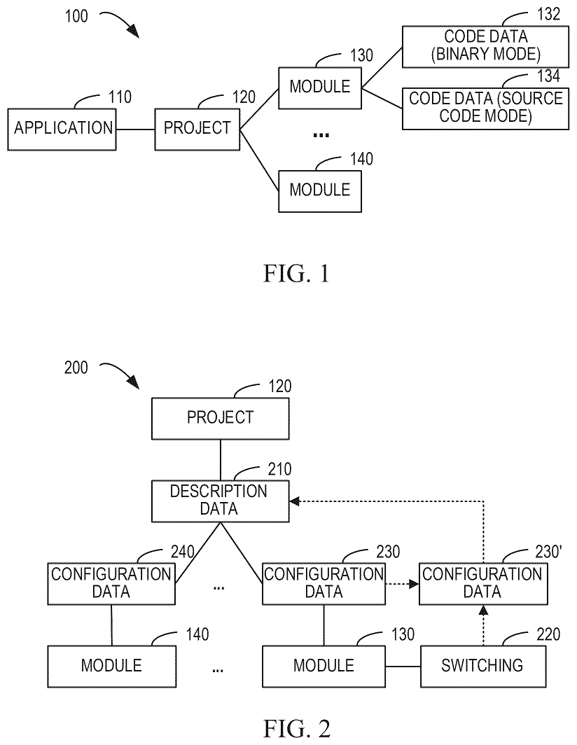

The number of modules included in an application is increasing, which results in a corresponding increase in the amount of code data in the project created to develop the application. Please refer to FIG. 1, which describes an application environment according to some implementations of the present disclosure. FIG. 1 illustrates a block diagram 100 of a development environment for an application according to some implementations of the present disclosure. As shown in FIG. 1, a project 120 may be created to develop an application 110. The project 120 may call a plurality of modules 130, . . . , and 140, and each module may implement a specific function, so as to implement an overall function of the application 110.

Here, there may be two modes for code data for implementing the functionality of a module: a binary mode and a source code mode. Specifically, during development of a certain module, the developer can edit the code data (i.e., code data 134) in the source code mode and adjust the corresponding functionality of the module. When the functionality of the module has been relatively stable, the code data may be switched to a binary mode (i.e., code data 132) in order to reduce the amount of data involved in the construction. At this point, the code data 134 in the source code mode may be constructed as code data 132 in the binary mode. Other modules (for example, the module 140) in the project may call the function of the module 130, and at this time, the code data in the binary mode can be directly called, so that the number of source codes that are actually involved can be greatly reduced, thereby reducing the waiting time.

In a large-scale project for application development, the number of source code constructs actually involved in the development process can be reduced by building a portion of codes into binary components in advance (e.g.,.aar format, and/or other formats). In this case, the coded constructed in advance are usually in the “binary mode”. A module that has been constructed as binary cannot be directly modified, and when the developer needs to modify the code data of “binary mode”, the code data needs to be switched to the “source code mode” through a specific tool. The developer may modify the code data in the “source code mode” and again publish it as a binary mode component for use by other modules.

Here, the switching from the binary mode to the source code mode refers to: pointing the reference of the code data in the binary mode to the code data in the source code mode stored at a certain position, and informing the integrated development environment to regenerate a project structure by synchronous operation. Currently, multiple tools have been developed for performing synchronous operations, however, multiple times of switching may need to be performed between a binary mode and a source code mode during development, the switching process will trigger resynchronization of code data, and synchronization may result in longer time delay. At this time, it is desirable to switch the code data in a more rapid and efficient manner, thereby improving the overall development efficiency of the application.

### SUMMARY OF CODE DATA MANAGEMENT

In order to at least partially solve the deficiencies in the prior art, a method for switching code data is proposed according to an exemplary implementation of the present disclosure. Referring to FIG. 2, FIG. 2 describes a summary of an exemplary implementation of the present disclosure. FIG. 2 illustrates a block diagram 200 for switching code data according to some implementations of the present disclosure. As shown in FIG. 2, the description data 210 of the project 120 may be obtained, and the description data 210 may describe an association relationship between code data of a plurality of modules (for example, the module 130, . . . , and the module 140) in the project 120 and the project 120.

Specifically, the association relationship may indicate that the project includes the module 130, . . . , and module 140. Here, there may be an association relationship between the various modules, such as, code data of the module 140 may depend on the code data of the module 130 (e.g., functions defined in the code data of the call module 130, etc.). The reference mode of the code data for a module of the plurality of modules may include at least one of a binary mode and a source code mode, and the description data 210 may reference the code data in a binary mode or source code mode. For example, code data of a module that is relatively stable in function may be referenced in a binary mode, and code data of the module being developed is referenced in source code mode.

In the development process, the function of the module in a certain binary mode may need to be adjusted, and at this time, the reference mode needs to be switched from the binary mode to the source code mode, so as to adjust the source code. Specifically, in response to determining that the first code data of the first module in the plurality of modules is switched from the binary mode to the source code mode, the second configuration data of the first module may be generated based on the first configuration data of the first module. In this case, the second configuration data may be used to update the description data of the project. Referring to FIG. 2, the reference mode of the module 130 may be switched 220 to the source code mode, and at this time, new configuration data 230′ may be generated to update the description data 210.

With example implementations of the present disclosure, it is possible to perform a specialized processing procedures for code data of the switched module, and only relevant code data of the switched module are synchronized, thereby improving development efficiency as there is no need to synchronize code data of the entire project.

### DETAILED PROCEDURE FOR CODE DATA MANAGEMENT

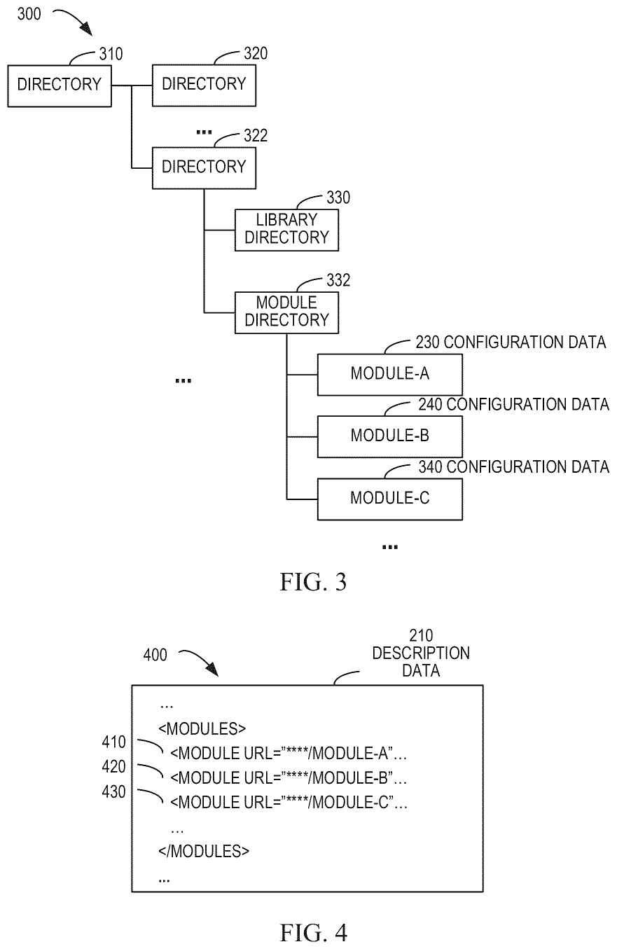

Having described a summary according to some implementations of the present disclosure, in the following, referring to FIG. 3, where a storage manner for data involved in the development process is described. FIG. 3 illustrates a block diagram 300 of a directory structure involved in a project according to some implementations of the present disclosure. As shown in FIG. 3, directory 310 may represent a root directory of a project and the directory may store a variety of data involved in the development process. For example, the directory 322 may store data for controlling the structure of the project, and the directory 320 may store data for implementing other functions. A subdirectory may be provided in the directory 322, for example, a library directory 330 may store relevant data of the code library called by each module, and the module directory 332 may store relevant data about the various modules called in the project.

For different integrated development environments, each directory may have a different naming manner. For example, in one development environment, the name of the directory 322 may be, for example, “.idea”, the name of the library directory 330 may be “libraries”, for example, the name of the module directory 332 may be “modules”, and so on. In other development environments, various directories may be named in other ways. The module directory 332 may include configuration data for various modules in the project. Assuming that the project includes modules A, B, and C, etc., at which point the module directory 332 may include configuration data for the various modules, for example, the configuration data 230 may be stored to the file “MODULE-A”, the configuration data 240 may be stored to the file “MODULE-B”, and the configuration data 340 may be stored to the file “MODULE-C”, and so on.

It should be understood that configuration data may be stored in different formats of files, for example, configuration data may be defined in an xml (extensible markup language) format; alternatively and/or additionally, configuration data may be stored in an “iml” format or other custom format in other application environments.

According to some implementations of the present disclosure, to generate the second configuration data, the metadata of the first module may be extracted from the first configuration data, and then the second configuration data may be generated based on the metadata. It should be understood that the switching process affects the reference mode of the first module, but does not completely modify the related metadata, and at this time, new configuration data may be generated based on the current metadata of the first module (i.e., the metadata before the switching).

Specifically, the metadata includes at least one of the following: a dependency relationship of the first code data, representing a dependency relationship among the modules involved in the project; an asset directory representing a storage location of various assets called in the project; a source code directory representing a storage location of the source code file (that is, the first code data in the source code mode) of the first module; a resource directory representing storage locations of various resources called in the project; and a root directory representing a storage location of the project in the computing device, for example, the directory 310 shown in FIG. 3. Generally, before and after the reference mode is switched, the metadata does not change. With example implementations of the present disclosure, the extracted metadata may be reused to generate new configuration data. In this way, the processing performance of the switching process can be improved, thereby improving the overall development efficiency.

According to some implementations of the present disclosure, the above metadata may be included in the configuration data of the first module. For example, special fields may be inserted in the configuration data to store the metadata described above. Alternatively, and/or additionally, the configuration data may include one or more files, for example, in some integrated development environments, the metadata may be stored in a separate project object model (abbreviated as POM) file; for another example, the metadata may be stored in a local and/or remote data repository of the computing device, as long as the foregoing metadata repository can be accessed in the switching phase.

According to some implementations of the present disclosure, after switching to the source code mode, the developer may edit the source code of the first module, thereby adjusting the function of the first module. With example implementations of the present disclosure, only code data of a module associated with the mode switching may be resynchronized. At this time, the workload involved in the switching process will be much smaller than the workload for synchronizing the relevant code data of the entire project, thereby improving the development efficiency.

According to some implementations of the present disclosure, in order to update the description data of the project, the first configuration data may be replaced with the second configuration data to update the association relationship. More details are described with reference to FIG. 3, assuming that the developer switches the reference mode of module A (corresponding to configuration data 230) from the binary mode to the source code mode, and new configuration data, such as file “MODULE-A′”, may be generated based on the file “MODULE-A”. Further, the file “MODULE-A” may be replaced with the file “MODULE-A′”. With example implementations of the present disclosure, the reference modes of the modules included in the project may be updated in real time, and the latest code data is called during the development of the application.

It should be understood that, since each module involved in the project is specified in the description data of the project, the corresponding portion in the description data needs to be replaced with the code data corresponding to the source code mode. According to some implementations of the present disclosure, to update the association relationship, a portion corresponding to the first configuration data may be determined in the description data of the project; and the portion may be replaced based on the second configuration data. More details are described with reference to FIG. 4, which illustrates a block diagram 400 depicting the structure of data 210 in accordance with some implementations of the present disclosure.

It should be understood that FIG. 4 merely schematically shows a portion of the data, for example, the rows 410, 420, and 430 represent that the project includes the module A, the module B, and the module C, respectively. In the case where module A is switched to the source code mode, the portion “MODULE-A” corresponding to module A may be replaced with “MODULE-A′”. It should be understood that FIG. 4 is merely illustrative and description data may be stored in other formats. For example, the module A may be specified as “MODULE-A” and the name may be utilized to refer to module A in the project. Further, an address of the code data corresponding to the name may be specified, for example, a name and a path of the source code file. At this point, the address of the code data corresponding to module A may be found and the replacement process is performed.

With example implementations of the present disclosure, the project may be updated in real-time, to call code data in the source code mode to participate in the construction process in the subsequent development process. In this case, in the development process, the code data in the binary mode is no longer referenced, but the code data in the source code mode is recompiled, and then the subsequent construction process is executed.

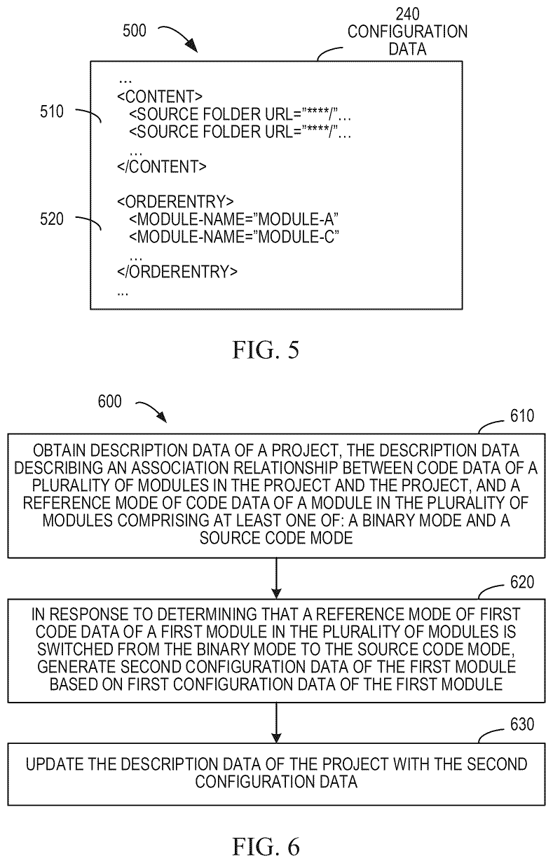

According to some implementations of the present disclosure, a portion of the configuration data corresponding to the first module may be modified such that the project calls the code data in the source code mode. FIG. 5 illustrates a block diagram 500 of a structure of configuration data according to some implementations of the present disclosure. As shown in FIG. 5, the content node 510 may, for example, describe a storage location of various related data, and at this time, the data of the content node 510 may be updated by using relevant information (for example, a name, a storage location, and the like) of the code data in the source code mode.

It should be understood that there may be an association relationship, for example, a dependency relationship, between modules in a project. At this time, the corresponding data of the module having the dependency relationship with the first module to be switched needs to be updated. According to some implementations of the present disclosure, in the process of updating the description data of the project, the second module in the plurality of modules may be determined based on the association relationship; and in response to determining that the second code data of the second module has an association relationship with the first code data of the first module, the second configuration data is updated by using the second configuration data.

Specifically, configuration data of each module in the project may be traversed, and a module having an association relationship with the switched module may be searched. Continuing with the above example, assuming that the module B is dependent on the module A and the module A is switched to source code mode, at which point the corresponding portion of configuration data of module B may be modified. Alternatively, and/or additionally, other modules with dependency relationship with the module A may be searched in a similar manner, and configuration data for other modules may be modified. With example implementations of the present disclosure, dependency relationships between various modules in the project may be updated in real-time so that the latest relevant data of the first module may be called.

According to some implementations of the present disclosure, a portion corresponding to the first configuration data may be determined in an order item node in the description data of the project; and the portion may be replaced based on the second configuration data. In this way, portions corresponding to code switching in the project can be conveniently searched and replaced, so that various changes in the project are reflected in real time, and development efficiency of the application is improved.

With continued reference to FIG. 5, names and/or other identifiers of other modules that have dependencies with the modules may be stored in the order item node 520 in the configuration data 240. Specifically, assuming that the configuration data 240 corresponds to the module B, at which point the order item node 520 indicates that the module B is dependent on the module A, and the module B is dependent on the module C. Assuming that only the reference mode of the module A is switched to the source code mode, the portion of order item node 520 in the configuration data 240 corresponding to module A, i.e., “MODULE-A”, may be modified to “MODULE-A” “. In this case, the module B will call each function defined in the code data in the source code mode, but no longer call the functions defined in the code data in the previously constructed binary mode.

The type of reference relationship among the various modules may be specified in the project. For example, the binary mode indicates that the module B calls the code data in the binary mode of the module A, and at this time, the module B directly calls a function in the constructed binary file. For another example, the source code mode indicates that the module B calls the code data in the source code mode of the module A, and the module B calls a function in the binary file constructed based on the source code.

According to some implementations of the present disclosure, in response to determining that the reference mode of the second code data for the first code data is a binary mode, the reference mode for the first code data is set to the binary mode. According to example implementations of the present disclosure, a specific reference manner may be set according to a specified mode. For example, for a module with a relatively stable function, a binary mode may be set in order to reduce the number of codes involved in construction to improve development efficiency.

According to some implementations of the present disclosure, in response to determining that the reference mode of the second code data for the first code data is the source code mode, the reference mode for the first code data is set to the source code mode. Specifically, for a module in development, the source code mode may be set so as to continuously update and test the function of the module, such that the updated function may be reflected to the application in real time, thereby providing an overall functional test.

According to some implementations of the present disclosure, a developer may modify code data in a source code mode, thereby performing a debugging and publishing process. Specifically, in response to receiving an update request for the first code data in the source code mode, third code data in the source code mode is generated; and the metadata is updated based on the third code data in the source code mode. With the example implementations of the present disclosure, the developer can constantly adjust the source code of the module, for example, the function of the module can be modified, and the potential error in the source code can be eliminated, so that the function of each module is more consistent with the design requirement.

Generally, the developer only adjusts the statements in the source code but does not modify the metadata of the code data, at this time, the metadata is not updated. In some cases, the developer may adjust the directory structure and/or other configurations of the project, which may result in metadata being updated. According to some implementations of the present disclosure, the second configuration data is determined based on the updated metadata. For example, the updated metadata may be stored in the POM file, so that the latest metadata may be directly read from the POM file in the subsequent development process. With example implementations of the present disclosure, it can be ensured that the second configuration data can always reflect the latest attributes of the code data of the module, thereby ensuring that the project can be updated in real time.

According to some implementations of the present disclosure, after the development and debugging of the source code has been completed, the developer may perform the construction and publishing processes. Specifically, in response to receiving a construction request for the third code data, the fourth code data in the binary mode is generated. With the example implementations of the present disclosure, the updated code data in binary mode may be generated through the construction operation when the update of the source code is completed. In this way, other modules in the project may call the code data in the binary mode according to the specified mode, thereby reducing the number of codes involved in the construction process.

With the example implementations of the present disclosure, a dedicated processing procedure may be performed for code data of a switched module, and only relevant code data of the switched module is synchronized, thereby improving development efficiency as there is no need to synchronize code data of the entire project.

### Example Processes

FIG. 6 illustrates a flowchart of a method 600 for switching code data according to some implementations of the present disclosure. At block 610, description data of a project is obtained, the description data describes an association relationship between code data of a plurality of modules in the project and the project, and a reference mode of code data of a module in the plurality of modules comprises at least any of: a binary mode and a source code mode. At block 620, in response to determining that a reference mode of first code data of a first module in the plurality of modules is switched from the binary mode to the source code mode, second configuration data for the first module is generated based on the first configuration data of the first module. At block 630, the description data of the project is updated with the second configuration data.

According to some implementations of the present disclosure, generating the second configuration data comprises: extracting metadata of the first module from the first configuration data, the metadata comprising at least any of: a dependency relationship with the first code data, an asset directory, a source code directory, a resource directory, and a root directory; and generating the second configuration data based on the metadata.

According to some implementations of the present disclosure, updating the description data of the project comprises: replacing the first configuration data with the second configuration data to update the association relationship.

According to some implementations of the present disclosure, updating the association relationship comprises: determining, from the description data of the project, a portion corresponding to the first configuration data; and replacing the portion based on the second configuration data.

According to some implementations of the present disclosure, the method further comprises: determining a second module in the plurality of modules based on the association relationship; and in response to determining that there is an association relationship between second code data of the second module and the first code data of the first module, updating second configuration data of the second module with the second configuration data.

According to some implementations of the present disclosure, updating second configuration data of the second module with the second configuration data comprises: determining, in an order item node in the second configuration data, a portion corresponding to the first configuration data; and replacing the portion based on the second configuration data.

According to some implementations of the present disclosure, the method further comprises at least any of: in response to determining that the reference mode of the second code data for the first code data is the binary mode, setting the reference mode for the first code data as the binary mode; and in response to determining that the reference mode of the second code data for the first code data is the source code mode, setting the reference mode for the first code data as the source code mode.

According to some implementations of the present disclosure, the method further comprises: in response to receiving an update request for the first code data in the source code mode, generating third code data in the source code mode; and updating the metadata based on the third code data in the source code mode.

According to some implementations of the present disclosure, the method further comprises: determining the second configuration data based on the updated metadata.

According to some implementations of the present disclosure, the method further comprises: generating fourth code data in the binary mode in response to receiving a construction request for the third code data.

### Example Apparatus and Device

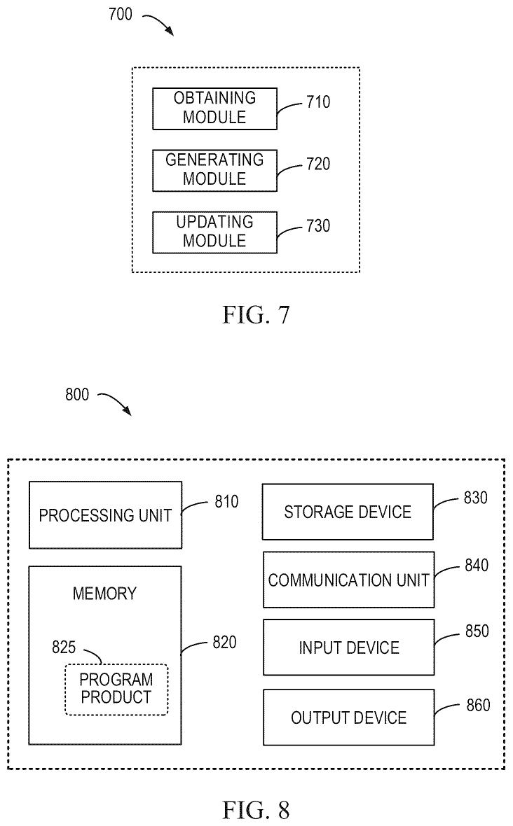

FIG. 7 illustrates a block diagram of an apparatus 700 for switching code data according to some implementations of the present disclosure. The apparatus 700 comprises: an obtaining module 710 configured to obtain description data of a project, the description data describing an association relationship between code data of a plurality of modules in the project and the project, and a reference mode of code data of a module in the plurality of modules comprising at least any of: a binary mode and a source code mode; a generating module 720 configured to generate, in response to determining that a reference mode of first code data of a first module in the plurality of modules is switched from the binary mode to the source code mode, second configuration data of the first module based on first configuration data of the first module; and an updating module 730 configured to update the description data of the project with the second configuration data.

According to some implementations of the present disclosure, the generating module 720 comprises: an extraction module configured to extract metadata of the first module from the first configuration data, the metadata comprising at least any of: a dependency relationship with the first code data, an asset directory, a source code directory, a resource directory, and a root directory; and a data generation module configured to generate the second configuration data based on the metadata.

According to some implementations of the present disclosure, the updating module 730 comprises: a replacing module configured to replace the first configuration data with the second configuration data to update the association relationship.

According to some implementations of the present disclosure, the replacement module comprises: a search module configured to determine, from the description data of the project, a portion corresponding to the first configuration data; and a data replacement module configured to replace the portion based on the second configuration data.

According to some implementations of the present disclosure, the apparatus 700 further comprises: a module determining module configured to determine a second module in the plurality of modules based on the association relationship; and a dependency updating module configured to update second configuration data of the second module with the second configuration data, in response to determining that there is an association relationship between second code data of the second module and the first code data of the first module.

According to some implementations of the present disclosure, the dependency updating module comprises: a search module configured to determine, in an order item node in the second configuration data, a portion corresponding to the first configuration data; and a data replacement module configured to replace the portion based on the second configuration data.

According to some implementations of the present disclosure, the apparatus 700 further comprises: a first setting module configured to set, in response to determining that the reference mode of the second code data for the first code data is the binary mode, the reference mode for the first code data as the binary mode.

According to some implementations of the present disclosure, the apparatus 700 further comprises a second setting module configured to set, in response to determining that the reference mode of the second code data for the first code data is the source code mode, the reference mode for the first code data as the source code mode.

According to some implementations of the present disclosure, the apparatus 700 further comprises: a source code updating module configured to generate, in response to receiving an update request for the first code data in the source code mode, third code data in the source code mode; and a metadata updating module configured to update the metadata based on the third code data in the source code mode.

According to some implementations of the present disclosure, the apparatus 700 further comprises: a configuration data determining module configured to determine the second configuration data based on the updated metadata.

According to some implementations of the present disclosure, the apparatus 700 further comprises a constructing module, configured to generate, in response to receiving a construction request for the third code data, fourth code data in the binary mode.

FIG. 8 illustrates a block diagram of a device 800 capable of implementing a plurality of implementations of the present disclosure. It should be understood that the computing device 800 shown in FIG. 8 is merely exemplary and should not constitute any limitation on the functionality and scope of the implementations described herein. The computing device 800 shown in FIG. 8 may be configured to implement the method described above.

As shown in FIG. 8, the computing device 800 is in the form of a general-purpose computing device. Components of the computing device 800 may include, but are not limited to, one or more processors or processing units 810, a memory 820, a storage device 830, one or more communications units 840, one or more input devices 850, and one or more output devices 860. The processing unit 810 may be an actual or virtual processor and can perform various processes according to programs stored in the memory 820. In a multiprocessor system, a plurality of processing units execute computer executable instructions in parallel, so as to improve the parallel processing capability of the computing device 800.

The computing device 800 typically includes a number of computer storage media. Such media may be any available media that are accessible by the computing device 800, including, but not limited to, volatile and non-volatile media, removable and non-removable media. The memory 820 may be a volatile memory (e. g., a register, cache, random access memory (RAM)), non-volatile memory (e.g., read-only memory (ROM), electrically erasable programmable read-only memory (EEPROM), flash memory), or some combination thereof. The storage device 830 may be a removable or non-removable medium and may include a machine-readable medium such as a flash drive, a magnetic disk, or any other medium that can be used to store information and/or data (such as training data used for training) and that can be accessed within the computing device 800.

The computing device 800 may further include additional removable/non-removable, volatile/nonvolatile storage media. Although not shown in FIG. 8, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 820 may include a computer program product 825 having one or more program modules configured to perform various methods or actions of various implementations of the present disclosure.

The communication unit 840 implements communication with other computing devices through a communication medium. In addition, functions of components of the computing device 800 may be implemented by a single computing cluster or a plurality of computing machines, and these computing machines can communicate through a communication connection. Thus, the computing device 800 may operate in a networked environment using logical connections to one or more other servers, network personal computers (PCs), or another network node.

The input device 850 may be one or more input devices such as a mouse, keyboard, trackball, etc. The output device 860 may be one or more output devices such as a display, speaker, printer, etc. The computing device 800 may also communicate with one or more external devices (not shown) such as a storage device, a display device, or the like through the communication unit 840 as required, and communicate with one or more devices that enable a user to interact with the computing device 800, or communicate with any device (c. g., a network card, a modem, or the like) that enables the computing device 800 to communicate with one or more other computing devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above. According to an exemplary implementation of the present disclosure, there is provided a computer program product having a computer program stored thereon, the program implement the methods described above when being executed by a processor.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for switching code data, comprising:
obtaining description data of a project, the description data describing an association relationship between code data of a plurality of modules in the project and the project, and a reference mode of code data of a module in the plurality of modules comprising at least one of: a binary mode and a source code mode;
in response to determining that a reference mode of first code data of a first module in the plurality of modules is switched from the binary mode to the source code mode, generating second configuration data of the first module based on first configuration data of the first module; and
updating the description data of the project with the second configuration data.

2. The method of claim 1, wherein generating the second configuration data comprises:
extracting metadata of the first module from the first configuration data, the metadata comprising at least any of: a dependency relationship with the first code data, an asset directory, a source code directory, a resource directory, and a root directory; and
generating the second configuration data based on the metadata.

3. The method of claim 1, wherein updating the description data of the project comprises:
replacing the first configuration data with the second configuration data to update the association relationship.

4. The method of claim 3, wherein updating the association relationship comprises:
determining, from the description data of the project, a portion corresponding to the first configuration data; and
replacing the portion based on the second configuration data.

5. The method of claim 1, further comprising:
determining a second module in the plurality of modules based on the association relationship; and
in response to determining that there is an association relationship between second code data of the second module and the first code data of the first module, updating second configuration data of the second module with the second configuration data.

6. The method of claim 5, wherein updating the second configuration data of the second module with the second configuration data comprises:
determining, in an order item node in the second configuration data, a portion corresponding to the first configuration data; and
replacing the portion based on the second configuration data.

7. The method of claim 6, further comprising at least any of:
in response to determining that the reference mode of the second code data for the first code data is the binary mode, setting the reference mode for the first code data as the binary mode; and
in response to determining that the reference mode of the second code data for the first code data is the source code mode, setting the reference mode for the first code data as the source code mode.

8. The method of claim 2, further comprising:
in response to receiving an update request for the first code data in the source code mode, generating third code data in the source code mode; and
updating the metadata based on the third code data in the source code mode.

9. The method of claim 8, further comprising: determining the second configuration data based on the updated metadata.

10. The method of claim 8, further comprising: generating fourth code data in the binary mode in response to receiving a construction request for the third code data.

11. An electronic device, comprising:
at least one processing unit; and
at least one memory coupled to the at least one processing unit and storing instructions for execution by the at least one processing unit, the instructions, when executed by the at least one processing unit, causing the electronic device to perform a method for switching code data, the method comprising:
obtaining description data of a project, the description data describing an association relationship between code data of a plurality of modules in the project and the project, and a reference mode of code data of a module in the plurality of modules comprising at least one of: a binary mode and a source code mode;
in response to determining that a reference mode of first code data of a first module in the plurality of modules is switched from the binary mode to the source code mode, generating second configuration data of the first module based on first configuration data of the first module; and
updating the description data of the project with the second configuration data.

12. The device of claim 11, wherein generating the second configuration data comprises:
extracting metadata of the first module from the first configuration data, the metadata comprising at least any of: a dependency relationship with the first code data, an asset directory, a source code directory, a resource directory, and a root directory; and
generating the second configuration data based on the metadata.

13. The device of claim 11, wherein updating the description data of the project comprises: replacing the first configuration data with the second configuration data to update the association relationship.

14. The device of claim 13, wherein updating the association relationship comprises:
determining, from the description data of the project, a portion corresponding to the first configuration data; and
replacing the portion based on the second configuration data.

15. The device of claim 11, wherein the method further comprises:
determining a second module in the plurality of modules based on the association relationship; and
in response to determining that there is an association relationship between second code data of the second module and the first code data of the first module, updating second configuration data of the second module with the second configuration data.

16. The device of claim 15, wherein updating the second configuration data of the second module with the second configuration data comprises:
determining, in an order item node in the second configuration data, a portion corresponding to the first configuration data; and
replacing the portion based on the second configuration data.

17. The device of claim 16, wherein the method further comprises at least any of:
in response to determining that the reference mode of the second code data for the first code data is the binary mode, setting the reference mode for the first code data as the binary mode; and
in response to determining that the reference mode of the second code data for the first code data is the source code mode, setting the reference mode for the first code data as the source code mode.

18. The device of claim 12, wherein the method further comprises:
in response to receiving an update request for the first code data in the source code mode, generating third code data in the source code mode; and
updating the metadata based on the third code data in the source code mode.

19. The device of claim 18, wherein the method further comprises at least any of:
determining the second configuration data based on the updated metadata; and
generating fourth code data in the binary mode in response to receiving a construction request for the third code data.

20. A non-transitory computer-readable storage medium having stored thereon a computer program which, when executed by a processor, causes the processor to implement a method for switching code data, the method comprising:
obtaining description data of a project, the description data describing an association relationship between code data of a plurality of modules in the project and the project, and a reference mode of code data of a module in the plurality of modules comprising at least one of: a binary mode and a source code mode;
in response to determining that a reference mode of first code data of a first module in the plurality of modules is switched from the binary mode to the source code mode, generating second configuration data of the first module based on first configuration data of the first module; and
updating the description data of the project with the second configuration data.
